(19) United States
(12) Patent Application Publication
(10) Pub. No.: US 2023/0082169 A1
(43) Pub. Date: Mar. 16, 2023

(54) NUTRIENT RICH, LOW GLYCEMIC INDEX (GI), GLUTEN FREE GRAINS-BASED PASTA

(71) Applicant: 100PERCENT NOURISHMENT PRIVATE LIMITED, Navi Mumbai (IN)

(72) Inventor: Bhuman Dani, Mumbai (IN)

(21) Appl. No.: 17/882,277

(22) Filed: Aug. 5, 2022

(30) Foreign Application Priority Data
Aug. 6, 2021 (IN) 202121035537

(51) Int. Cl. A23L 7/109; A23L 11/00

(52) U.S. Cl. CPC A23L 7/109; A23L 11/05

(57) ABSTRACT

The present disclosure provides a high nutrition gluten free grains-based food composition. The gluten free rains-based food composition includes (i) at least one legume-based ingredient, (ii) at least one cereal-based ingredient, (iii) at least one pseudo cereal ingredient, (iv) at least one starch source, (v) at least one gum source, and (vi) at least one seed-based ingredient. The gluten free grains-based food composition may additionally include macronutrients and minerals. The present disclosure also provides a high nutrition gluten free grains-based pasta and a method of producing the high nutrition gluten free grains-based pasta using the high nutrition gluten free grains-based food composition.

### CROSS-REFERENCE TO PRIOR FILED PATENT APPLICATIONS

This application claims priority from the Indian provisional application no. 202121035537 filed on Aug. 6, 2021, which is herein incorporated by reference

### BACKGROUND

### Technical Field

The present disclosure relates generally to food compositions, and more particularly, the present disclosure relates to high nutrition, low glycemic index, gluten free, grains-based food composition with high shelf life, sensorially acceptable taste and improved protein digestibility. Moreover, the present disclosure relates to a high nutrition, low glycemic index, gluten free, grains-based pasta and a method of producing the high nutrition, low glycemic index, gluten free, grains-based pasta using the grains-based food composition.

### Description of the Related Art

Food is any substance that is consumed to meet nutritional requirements of an individual or organism. Some people may have allergies or sensitivities to foods that are not problematic to most people. However, food allergies may cause life-threatening reactions, which require immediate medical intervention. More than 70 foods have been reported to cause food allergies. Eight major allergens such as soy, wheat, dairy, fish, shellfish, peanuts, tree nuts, and eggs, account for about 90% of food allergies in the United States of America (USA). In the United Kingdom (UK), there are 14 major allergens, which also includes celery, lupin, mollusks, mustard, sesame seeds, and sulfur dioxide (sulfites).

Over last 10 years, the number of food allergy cases has doubled and over last 25 years, there has been a 500% rise in hospital admissions in the UK. Between 1992 and 2012, there was a 615% increase in hospital admissions for anaphylaxis. In 2013, it was estimated that between 220 and 250 million people in the world could be suffering from food allergy or intolerance. A recent survey by the Food Standards Agency (FSA) and Allergy UK found that, 1 in 4 people with a food allergy have suffered a reaction while eating out. An only way for allergic individuals to manage food allergies is to avoid eating the food that causes the allergy.

For example, pasta may cause allergy to people who have allergy to gluten. Since, pasta is typically made from wheat which has an inert protein called gluten, which is sticky in nature giving strength to the pasta and chewiness. But gluten is not as high in nutrition as other proteins and is not a complete protein either.

Existing approaches produce pastas that are predominantly made from wheat with 10-15% of other super-grains such as jowar, ragi, millets, etc. to or predominantly made from rice, which is not high in nutrition either. Sensory wise, these pasta products are usually inferior to refined wheat pasta. There have been attempts to make high protein pasta or high fiber pasta, but they are not necessarily gluten free pasta. World Health Organization (WHO) suggests an intake of >25 g of fiber per day.

Therefore, there arises a need to address the aforementioned technical drawbacks in existing pasta compositions.

### SUMMARY

In view of the foregoing, a nutrition rich, low glycemic index (GI), gluten free grains-based pasta is provided. The nutrition rich, low glycemic index (GI), gluten free grains-based pasta includes (i) at least one legume-based ingredient, (ii) at least one cereal-based ingredient, (iii) at least one pseudo cereal ingredient, (iv) at least one starch source, (v) at least one gum source, and (vi) at least one seed-based ingredient, characterized in that the pasta includes (a) 60% weight/weight (w/w) to 90% w/w of the at least one legume-based ingredient; (b) 5% w/w to 15% w/w of the at least one cereal-based ingredient; (c) 5% w/w to 10% w/w of the at least one pseudo cereal ingredient; (d) 1% w/w to 8% w/w of the at least one starch source; (e) 0.5% w/w to 1.5% w/w of the at least one gum source; and (f) 0.2% w/w to 0.7% w/w of the at least one seed-based ingredient. The pasta is shelf stable at an ambient condition.

In some embodiments, at least one legume-based ingredient includes (i) 25% w/w to 35% w/w of a first legume-based ingredient that includes chickpea flour, (ii) 25% w/w to 35% w/w of a second legume-based ingredient that includes red lentil flour, and (iii) 10% w/w to 20% w/w of a third legume-based ingredient that includes mung bean flour. The at least one cereal-based ingredient includes 5% w/w to 15% w/w of brown rice flour. The at least one pseudo cereal ingredient includes 5% w/w to 10% w/w of buckwheat flour. The at least one starch source ingredient includes 1% w/w to 8% w/w of tapioca starch flour. The at least one gum source includes 0.5% w/w to 1.5% w/w of guar gum. The at least one seed-based ingredient includes 0.2% w/w to 0.7% w/w of flax seed flour.

In some embodiments, the pasta includes a low GI index of 52.94.

In some embodiments, the pasta has the shelf life of 18 months at an ambient condition.

In some embodiments, the pasta has a pH ranging from 6 to 6.65.

In some embodiments, the pasta (100 g) has a nutrition profile that includes (i) 344 kilocalories (kcal) of energy, (ii) 18 grams (g) of protein, (iii) 68 g of carbohydrates, (iv) 1 g of total sugar, (v) 14 g of dietary fiber, (vi) 3 g of total fat, (vii) 0.4 g of saturated fat, (viii) 0.5 g of monosaturated fatty acids, and (ix) 1.2 g of polyunsaturated fatty acids.

In some embodiments, pasta (100 gram) provides minerals that includes (i) 80 milligrams (mg) of calcium (Ca), (ii) 137. 7 mg of magnesium (Mg), (iii) 935 mg of potassium (K), (iv) 4 mg of iron (Fe), and (v) 2.5 mg of zinc (Zn).

In some embodiments, the pasta has a protein digestibility-corrected amino acid score (PDCAAS) of 0.8 which is higher than a regular wheat pasta.

In some embodiments, the pasta includes (i) 14.53 g digestible protein in 100 grams (g). The pasta includes, (i) 50.8 milligrams (mg) of digestible lysine per gram of protein, (ii) 32.7 mg of digestible threonine per gram of protein, (iii) 10.8 mg of digestible tryptophan per gram of protein, (iv) 38.9 mg of digestible histidine per gram of protein, (v) 35 mg of digestible isoleucine per gram of protein, (vi) 66 mg of digestible leucine per gram of protein, (vii) 38.4 mg of digestible valine per gram of protein, (viii) 103.9 mg of digestible phenylalanine and tyrosine per gram of protein, and (ix) 44.6 mg of digestible methionine and cysteine per g of protein.

In some embodiments, the pasta has a sensory score of 4.8 which is similar to a regular wheat pasta.

According to another aspect, a method of producing a high nutrition, low glycemic index (GI), gluten free grains-based pasta is provided. The method includes (i) preparing a grain flour dry mixture by grinding and mixing (a) 60% weight/weight (w/w) to 90% w/w of at least one legume-based ingredient, (b) 5% w/w to 15% w/w of the at least one cereal-based ingredient, (c) % w/w to 10% w/w of at least one pseudo cereal ingredient and (d) 0.2% w/w to 0.7% w/w of seed-based ingredient into with a particle size ranging from 350 to 500 microns (μ), (ii) mixing the grain flour dry mixture with 1% w/w to 8% w/w of at least one starch source and 0.5% w/w to 1.5% w/w of at least one gum source; (iii) forming a grain flour wet mixture by mixing the grain flour dry mixture along with starch and gum with water, a ratio of water and grain flour dry mixture is 25:75, (iv) producing an extruded wet pasta by passing the grain flour wet mixture through a hot extruder with steam, the hot extruder is at a temperature ranging from 90-110 degree Celsius (° C.), and (v) producing the high nutrition, low glycemic index (GI), gluten free grains-based pasta by passing the extruded wet pasta through a dryer which is at a temperature ranging from 55-60° C. for 35-40 minutes until a moisture content below 11% w/w. The pasta has a shelf life from 0 to 18 months at an ambient condition.

These and other aspects of the embodiments herein will be better appreciated and understood when considered in conjunction with the following description and the accompanying drawings. It should be understood, however, that the following descriptions, while indicating preferred embodiments and numerous specific details thereof, 5 are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed descriptions with reference to the drawings, in which:

FIG. 1 illustrates a nutrition rich, low glycemic index (GI), gluten free grains-based food composition, according to some embodiments herein;

FIG. 2 is a graphical representation of comparative sensory analysis between a nutrition rich, low glycemic index (GI), gluten free grains-based pasta and a wheat pasta, according to some embodiments herein;

FIG. 3 illustrates a method of producing a nutrition rich, low glycemic index (GI), gluten free grains-based pasta, according to some embodiments herein; and

FIGS. 4A and 4B illustrate exemplary undesired results of pasta due to changing the concentration ranges of ingredients of the gluten free grains-based pasta.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

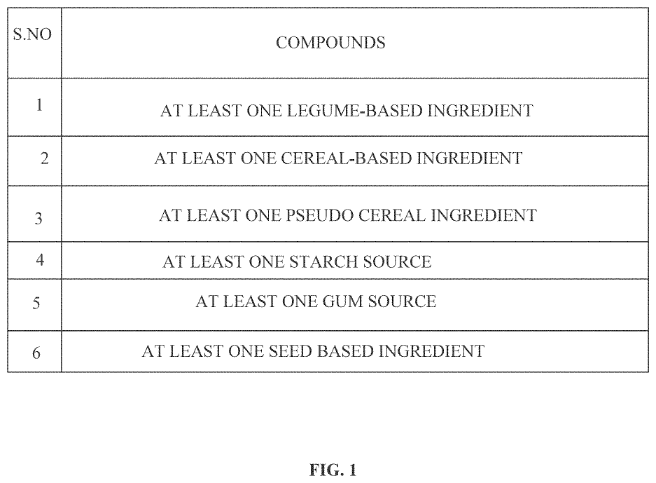

As mentioned, there remains a need for a high nutritious, gluten free food composition for producing pasta. The embodiments herein achieve this by providing a gluten free grains-based food composition with high nutrition, sensorially acceptable taste, improved protein digestibility and high shelf life. The gluten free grains-based food composition is especially suitable for protein and fiber deficient, celiac and diabetic populations. Herein, further embodiments provide a gluten free grains-based pasta with high nutrition, low glycemic index (GI), sensorially acceptable taste, improved protein digestibility and high shelf life and a method of producing a nutrition rich, low glycemic index (GI), gluten free grains-based pasta using the gluten free grains-based food composition. Referring now to the drawings and more particularly to FIGS. 1 through 4B, where similar reference characters denote corresponding features consistently throughout the figures, there are shown preferred embodiments.

As used herein, several terms are defined below:

The term “food composition” used herein refers to an edible composition comprising edible materials, ingredients, additives, etc.

The term “gluten free grains based pasta/pasta” used herein refers to pasta that is produced using the food composition of the present disclosure.

The term “shelf-life” used herein refers to a time period within which the pasta remains acceptable for organoleptic, nutritional, and safety purposes, for a consumer or a retailer. Shelf life depends on physical, microbiological and chemical processes taking place in the product when stored under recommended condition. Chemical changes include oxidation of food, change and loss in colour, change in pH, enzymatic deterioration. Physical tests assessed are moisture content, textural changes, breakage or clumping of food. Microbial assessment for absence of pathogenic microorganism as per regulatory standards is carried out. Apart from microbial and chemical shelf life of food products, sensory aspects of the food products like its flavor, texture and appearance for example play a vital role in consumer acceptability.

The term “gluten-free” used herein refers to an attribute of food composition or pasta that does not contain gluten.

The term “low glycemic index (GI)” used herein refers to a GI value of 55 or less.

The term “nutrient rich or high nutrition” used herein refers to an attribute of food composition or pasta that comprises high protein, high fiber, low net carbohydrates, and minerals.

The term “regular wheat pasta” used herein refers to a pasta made from wheat and contains gluten.

The term “improved protein digestibility” used herein refers to an attribute of a food composition or pasta that comprises protein digestibility-corrected amino acid score (PDCAAS) of 0.8.

FIG. 1 illustrates a nutrition rich, low glycemic index (GI), gluten free grains-based food composition, according to some embodiments herein. The food composition includes (i) at least one legume-based ingredient, (ii) at least one cereal-based ingredient, (iii) at least one pseudo cereal ingredient, (iv) at least one starch source, (v) at least one gum source, and (vi) at least one seed-based ingredient. The grains-based food composition provides macronutrients. The grains-based food composition additionally provides minerals.

The legume-based ingredient includes a first legume-based ingredient, a second legume-based ingredient, and a third legume-based ingredient. The first legume based ingredient is chickpea flour. The second legume-based ingredient is lentil flour. The third legume-based ingredient is mung bean flour or green moong dal flour. The legume-based ingredient includes chickpea flour, lentil flour, and mung bean flour or green moong dal flour. The chickpea flour may be bengal gram flour or garbanzo bean flour or egyptian pea flour. The grains-based food composition includes 60% weight/weight (w/w) to 90% w/w of the at least one legume-based ingredient. In some embodiments, the chickpea flour is selected from a group including green chickpea flour, black chickpea flour, brown chickpea flour, red chickpea flour and beige chickpea flour. The chickpea flour includes fiber, potassium, folate and iron. In some embodiments, the chickpea flour is unrefined chickpea flour. In some embodiments, the chickpea flour is freshly ground chickpea flour. The chickpea flour may be in a particle size ranging from 350 to 500 microns (O. The grains-based food composition includes 25% w/w to 35% w/w of the chickpea flour.

In some embodiments, the lentil flour is selected from a group including red lentil flour, brown lentil flour, black lentil flour, or green lentil flour. The lentil flour may be red lentil flour. The lentil flour includes fiber, vitamins, minerals, and protein. In some embodiments, the lentil flour is unrefined lentil flour. In some embodiments, the lentil flour is freshly ground lentil flour. The lentil flour may be in a particle size ranging from 350 to 500μ. The grains-based food composition includes 25% w/w to 35% w/w of the lentil flour.

The mung bean flour is unrefined mung bean flour. In some embodiments, the mung bean flour is freshly ground mung bean flour. The mung bean flour may be in a particle size ranging from 350 to 500 The mung bean flour includes fiber, vitamins, minerals, and protein. The grains-based food composition includes 10% w/w to 20% w/w of the mung bean flour.

The cereal-based ingredient includes rice flour. In some embodiments, the rice flour is selected from a group including brown rice flour, white rice flour, red rice flour or black rice flour. The rice flour may be brown rice flour. The rice flour includes fiber, vitamins, minerals, and protein. The rice flour is unrefined rice flour. In some embodiments, the rice flour is freshly ground rice flour. The rice flour may be in a particle size ranging from 350 to 500μ. The grains-based food composition includes 5% w/w to 15% w/w of rice flour.

The pseudo cereal ingredient includes buckwheat flour. In some embodiments, the pseudo cereal ingredient includes at least one of amaranth, or quinoa. The buckwheat flour includes fiber, vitamins, minerals, and protein. The buckwheat flour is unrefined buckwheat flour. In some embodiments, the buckwheat flour is freshly ground buckwheat flour. The buckwheat flour may be in a particle size ranging from 350 to 500μ. The grains-based food composition includes 5% w/w to 10% w/w of buckwheat flour.

The starch source includes tuber starch. The tuber starch may be tapioca starch. In some embodiments, the starch source includes at least one of potato starch, corn starch, rice starch, beans starch, or sorghum starch. The grains-based food composition includes 1 w/w to 8% w/w of tapioca starch flour.

The gum source includes guar gum. In some embodiments, the gum source includes at least one of xanthan gum or acacia gum. The grains-based food composition includes 0.5% w/w to 1.5% w/w of guar gum.

The seed-based ingredient includes flaxseed flour. The grains-based food composition includes 2% w/w to 0.7% w/w of flax seed flour.

The macronutrients include at least one of protein and dietary fiber. In some embodiments, the macronutrients include at least one of 18 grams (g) of protein per 100 g of the grains-based food composition and 14 g of dietary fiber per 100 g of the grains-based food composition.

The minerals include at least one of calcium (Ca), magnesium (Mg), potassium (K), iron (Fe), or zinc (Zn). The minerals may include at least one of 80 milligrams (mg) of calcium (Ca), 137.7 mg of magnesium (Mg), 935 mg of potassium (K), 4 mg of iron (Fe), or 2.5 mg of zinc (Zn).

In some embodiments, the nutrition rich, low glycemic index (GI), gluten free grains-based food composition includes (i) 25% w/w to 35% w/w of chickpea flour, (ii) 25% w/w to 35% w/w of red lentil flour, (iii) 10% w/w to 20% w/w of green moong dal flour or mung bean flour, (iv) 5% w/w to 15% w/w of brown rice flour, (v) 5% w/w to 10% w/w of buckwheat flour, (vi) 1% w/w to 8% w/w of tapioca starch (vii) 0.5% w/w to 1.5% of guar gum, and (viii) 0.2% w/w to 0.7% w/w of flaxseed flour.

In some embodiments, the nutrition rich, low glycemic index (GI), gluten free grains-based food composition includes (i) 30% of chickpea flour, (ii) 30% of red lentil flour, (iii) 15% of green moong dal flour or mung bean flour, (iv) 10% of brown rice flour, (v) 10% of buckwheat flour, (vi) 4% of tapioca starch (vii) 0.5% of guar gum, and (viii) 0.5% of flaxseed flour. The grains present in the gluten free grains-based food composition may be indigenous varieties. Chickpea, red lentil, green moong dal, brown rice, buckwheat, and flaxseed are procured from a trader in Udham Singh Nagar district in a state of Uttarakhand. Guar gum is procured from a trader in Ahmedabad in a state of Gujarat. Tapioca starch is procured from a trader in Salem in a state of Tamil Nadu.

The gluten free, grains-based food composition includes high protein, high fiber and low net carbohydrates thereby the gluten free grains-based food composition is suitable for protein and fiber deficient, celiac and diabetic populations. As the gluten free grains-based food composition is rich in protein and fiber, the gluten free grains-based food composition satisfies nutritional requirement of an individual. The gluten free grains-based food composition includes low glycemic index (GI), thereby suitable for diabetic populations. Further, the gluten free grains-based food composition includes high shelf life, sensorially acceptable taste and improved protein digestibility.

The gluten free grains-based food composition may enable digestion, lower blood pressure, improves red blood cell formation, and reduce fatigue. In some embodiments, the gluten free grains-based food composition shores up bones, heal wounds, bolsters immune system, improves body growth and development, strengthen bones and teeth, transforms food into energy, reduces appetite and hunger levels, increases muscle mass and strength, reduces cravings and desire for late-night snacking, boosts metabolism and increases fat burning and maintains weight loss. The gluten free grains-based food composition is free of allergens.

In some embodiments, a gluten free grains-based pasta is produced using the gluten free grains-based food composition. The gluten free grains-based food composition is used to produce any type of pasta that includes, but not limited to, Spaghetti, Penne, Lasagne, Ravioli, Linguine, Rigatoni, Farfalle, Fusilli, Macaroni, and Cannelloni.

In some embodiments, the gluten free grains-based food composition is used to produce noodles, crackers, and bakery products.

In one embodiment, the gluten free grains-based pasta includes (i) at least one legume-based ingredient, (ii) at least one cereal-based ingredient, (iii) at least one pseudo cereal ingredient, (iv) at least one starch source, (v) at least one gum source, and (vi) at least one seed-based ingredient.

In some embodiments, the gluten free grains-based pasta includes (i) 60% w/w to 90% w/w of the at least one legume-based ingredient; (ii) 5% w/w to 15% w/w of the at least one cereal-based ingredient; (iii) 5% w/w to 10% w/w of the at least one pseudo cereal ingredient; (iv) 1% w/w to 8% w/w of the at least one starch source; (v) 0.5% w/w to 1.5% w/w of the at least one gum source; and (vi) 0.2% w/w to 0.7% w/w of the at least one seed-based ingredient.

In some embodiments, the gluten free grains-based pasta includes (i) 25% w/w to 35% w/w of chickpea flour, (ii) 25% w/w to 35% w/w of red lentil flour, (iii) 10% w/w to 20% w/w of mung bean flour; (iv) 5% w/w to 15% w/w of brown rice flour; (iv) 5% w/w to 10% w/w of buckwheat flour; (v) 1% w/w to 8% w/w of tapioca starch flour; (v) 0.5% w/w to 1.5% w/w of guar gum; and (vi) 0. 2% w/w to 0.7% w/w of flax seed flour. The w/w is g/g or kg/kg.

In another embodiment, the gluten free grains-based pasta includes (i) 30% of chickpea flour, (ii) 30% of red lentil flour, (iii) 15% of green moong dal flour or mung bean flour, (iv) 10% of brown rice flour, (v) 10% of buckwheat flour, (vi) 4% of tapioca starch, (vii) 0.5% of guar gum, and (viii) 0.5% of flaxseed flour.

In some embodiments, the gluten free grains-based pasta further includes macronutrients that include at least one of 18 grams (g) of protein per 100 g of the gluten free grains-based pasta and 14 g of dietary fiber per 100 g of the gluten free grains-based pasta.

In some embodiments, the gluten free grains-based pasta further includes at least one of 80 milligrams (mg) of calcium (Ca), 137.7 mg of magnesium (Mg), 935 mg of potassium (K), 4 mg of iron (Fe), or 2.5 mg of zinc (Zn).

The gluten free grains-based pasta includes low GI value of 52.94, thereby the pasta is suitable for diabetic population. The pasta is tested for GI value using STP/AAL/MA/004 method.

The gluten free grains-based pasta delivers overall protein 1.5× higher than regular refined wheat pasta, overall fiber 4.5× higher than regular refined wheat pasta (12 g protein and 3 g of fiber) while the net carbohydrate is 20% fewer than regular refined wheat pasta. The gluten free grains-based pasta includes high shelf life, sensorially acceptable taste.

One serve of gluten free grains-based pasta (60 g of uncooked pasta) including the gluten free grains-based food composition may provide protein content equivalent to 450 milliliters (ml) of cow's milk, used for lactose intolerant people. Also, one serve of gluten free grains-based pasta (60 g of uncooked pasta) may provide fiber equivalent to 73 g of oats. The gluten free grains-based pasta with low fat content and high fiber helps in weight management, and also per serve of the gluten free grains-based pasta may provide 1 g of soluble fiber which helps in maintaining lipid profile thereby boosting heart health.

Table 1 illustrates a nutritional profile of the gluten free grains-based pasta according to some embodiments herein.

TABLE 1

| | | % Recommended |
|---|---|---|
| | | Dietary Allowance |
| | | (RDA) per serve (One |
| Nutritional Information | Per 100 g | serve = 60 g) |
| Energy (kilocalorie, kcal) | 344 | 10 |
| Protein (g) | 18 | 20 |
| Carbohydrates (g) | 68 | |
| Total Sugars (g) | 1 | |
| Added Sugars (g) | 0 | 0 |
| Dietary Fiber (g) | 14 | |
| Total Fat (g) | 3 | 3 |
| Saturated Fat (g) | 0.4 | 1 |
| Trans Fat (g) | 0 | 0 |
| Monosaturated Fatty Acids (g) | 0.5 | |
| Polyunsaturated Fatty Acids (g) | 1.2 | |
| Cholesterol (mg) | 0 | |
| Sodium (mg) | 16 | 0.5 |

% RDA calculated based on Indian Council of Medical Research (ICMR) 2020 (Sedentary Man)

Table 2 illustrates an amino acid profile of the gluten free grains-based pasta according to some embodiments herein.

TABLE 2

| Amino Acid | mg/g protein |
|---|---|
| Lysine | 50.8 |
| Threonine | 32.7 |
| Tryptophan | 10.8 |
| Histidine | 38.9 |
| Isoleucine | 35 |
| Leucine | 66 |
| Valine | 38.4 |
| Phenylalanine + Tyrosine | 103.9 |
| Methionine + Cysteine | 44.6 |

Table 3 illustrates digestible protein of the gluten free grains-based pasta according to some embodiments herein.

TABLE 3

| | |
|---|---|
| Digestible protein in recipe (g/100 g pasta) | 14.53 |
| Digestible Lysine (mg/g protein) | 50.8 |
| Digestible Threonine (mg/g protein) | 32.7 |
| Digestible Tryptophan (mg/g protein) | 10.8 |
| Digestible Histidine (mg/g protein) | 38.9 |
| Digestible Isoleucine (mg/g protein) | 35 |
| Digestible Leucine (mg/g protein) | 66 |
| Digestible Valine (mg/g protein) | 38.4 |
| Digestible Phenylalanine + Tyrosine (mg/g | 103.9 |
| protein) | |
| Digestible Methionine + Cysteine (mg/g | 44.6 |
| protein) | |

Table 4 illustrates comparison of sensory score between the gluten free grains-based pasta and wheat pasta made from durum wheat on hedonic scale of 1-5 with 1 as lowest and 5 as highest score.

TABLE 4

| | | | | | | Overall |
|---|---|---|---|---|---|---|
| Name of Pasta | Color | Texture | Chewiness | Springiness | Elasticity | Acceptance |
| Gluten Free grains- | 4.5 | 5 | 4 | 4.5 | 4.7 | 4.8 |
| based Pasta | | | | | | |
| Wheat pasta | 4.5 | 4 | 5 | 5 | 5 | 4.9 |

It is observed from the Table 4 that the gluten free grains-based pasta has color, texture, chewiness, springiness, and elasticity similar to the wheat pasta made from durum wheat. Further, overall sensory acceptance score of the gluten free grains-based pasta is similar to the wheat pasta made from durum wheat.

Table 5 illustrates protein digestibility-corrected amino acid score (PDCAAS) of rice, wheat, ragi, green gram, red lentil, chickpea and gluten free grains-based pasta that is made of chickpea flour, red lentil flour, green moong dal flour or mung bean flour, brown rice flour, buckwheat flour, tapioca starch, guar gum, and flaxseed flour.

TABLE 5

| | | | | | | | Gluten free |
|---|---|---|---|---|---|---|---|
| | | | | Green | | | grains-based |
| Parameter | Rice | Wheat | Ragi | gram | Red lentil | Chickpea | pasta |
| Protein | 7.9 | 10.6 | 7.2 | 22.5 | 21.7 | 18.8 | 18 |
| (g/100 g) | | | | | | | |
| PDCAAS* | 0.65 | 0.54 | 0.46 | 0.63 | 0.54 | 0.52 | 0.8 |

*Calculated based on method adopted from FAO/WHO/UNU, 1985

PDCAAS is estimated to assess protein quality of a food product. The body needs protein to grow, heal, and carry about nearly every chemical reaction in the body. Both quality and quantity of the protein are necessary for good nourishment. From the Table 5, it is observed that PDCAAS of individual grains such as rice, wheat, ragi and red lentil, green gram is on a lower side, that is in a range from 0.4-0.65. Pasta is usually made with wheat which has a lower PDCAAS of 0.4.

The gluten free grains-based pasta of the present disclosure is made with a combination of chickpea flour, red lentil flour, green moong dal flour or mung bean flour, brown rice flour, buckwheat flour, tapioca starch, guar gum, and flaxseed flour. The gluten free grains-based pasta of the present disclosure includes chickpea, mung, rice which has a PDCAAS of 0.5-0.65 to pull up the PDCAAS of the gluten free grains-based pasta to 0.8 which is higher in comparison to regular wheat pasta.

The gluten free grains-based pasta includes at least 18 months of shelf life. The prepared pasta products were undergone a laboratory test to monitor or test chemical, microbiological, physical, and sensory attributes of the pasta products that act as indicators of its quality over a defined period of time at pre-determined time interval and the results were submitted in below tables. An accelerated shelf-life studies are performed in order to evaluate the shelf life of the pasta products. Accelerated shelf life testing is a form of stability testing in which a product is stored at elevated stress conditions to rapidly increase the rate of deterioration. The accelerated shelf life study which is universally accepted method, allows a reduction in the time needed to estimate pasta products shelf life. Accordingly, shelf life study under accelerated conditions from 0 to 3 months enables to evaluate shelf life up to 18 months. The accelerated storage conditions include 38° C. & 90% Relative humidity (RH).

Table 6 illustrates shelf life results of Fusilli Pasta which was manufactured on Jan. 19, 2022.

TABLE 6

| | | | Date of analysis | | | |
|---|---|---|---|---|---|---|
| | | | 17 Feb. 2022 | 5 May 2022 | 16 Jun. 2022 | Specified |
| Tests | Phase | Units | A | B | C | Limits |
| MICROBIOLOGICAL | Total viable | cfu/g | <10 | 9.0 × 10¹ | 9.5 × 10¹ | Max 10⁴ |
| | count | | | | | |
| | Coliform | cfu/g | <10 | <10 | <10 | Max 10² |
| | E coli | org/g | Absent | Absent | Absent | Absent |
| | Salmonella | org/25 g | Absent | Absent | Absent | Absent |
| | Staphylococcus | org/g | Absent | Absent | Absent | Absent |
| | aureus | | | | | |
| | Yeast | cfu/g | <10 | <10 | <10 | Max 10² |
| | Mold | cfu/g | <10 | 2.0 × 10¹ | 2.5 × 10¹ | Max 10² |
| CHEMICAL | pH | — | 6.06 | 6.05 | 6.00 | Not |
| | | | | | | Specified |
| | Acidity as | g/100 g | 0.63 | 0.75 | 0.89 | Not |
| | citric acid | | | | | Specified |
| | anhydrous | | | | | |
| | Moisture | g/100 g | 6.92 | 7.54 | 7.80 | Max 12.5 |
| ORGANOLEPTIC | Appearance in | — | 5 | 5 | 5 | 3 to 5 |
| | terms of colour | | | | | |
| | Odour | — | 5 | 5 | 5 | 3 to 5 |
| | Taste | — | NA | NA | NA | 3 to 5 |
| | Texture/ | — | 5 | 5 | 5 | 3 to 5 |
| | Consistency | | | | | |

| | | | |
|---|---|---|---|
| Shelf life obtained | 1 | 12 | 18 |

Table 7 illustrates shelf life results of Macaroni Pasta which was manufactured on Jan. 19, 2022.

TABLE 7

| | | | Date of analysis | | | |
|---|---|---|---|---|---|---|
| | | | 17 Feb. 2022 | 5 May 2022 | 16 Jun. 2022 | Specified |
| Tests | Phase | Units | A | B | C | Limits |
| MICROBIOLOGICAL | Total viable | cfu/g | <10 | 7.0 × 10¹ | 8.0 × 10¹ | Max 10⁴ |
| | count | | | | | |
| | Coliform | cfu/g | <10 | <10 | <10 | Max 10² |
| | E coli | org/g | Absent | Absent | Absent | Absent |
| | Salmonella | org/25 g | Absent | Absent | Absent | Absent |
| | Staphylococcus | org/g | Absent | Absent | Absent | Absent |
| | aureus | | | | | |
| | Yeast | cfu/g | <10 | <10 | <10 | Max 10² |
| | Mold | cfu/g | <10 | 5.0 × 10¹ | 5.5 × 10¹ | Max 10² |
| CHEMICAL | pH | — | 6.05 | 6.02 | 5.98 | Not |
| | | | | | | Specified |
| | Acidity as | g/100 g | 0.66 | 0.74 | 0.83 | Not |
| | citric acid | | | | | Specified |
| | anhydrous | | | | | |
| | Moisture | g/100 g | 7.36 | 8.00 | 8.21 | Max 12.5 |
| ORGANOLEPTIC | Appearance in | — | 5 | 5 | 5 | 3 to 5 |
| | terms of colour | | | | | |
| | Odour | — | 5 | 5 | 5 | 3 to 5 |
| | Taste | — | NA | NA | NA | 3 to 5 |
| | Texture/ | — | 5 | 5 | 5 | 3 to 5 |
| | Consistency | | | | | |

| | | | |
|---|---|---|---|
| Shelf life obtained | 1 | 12 | 18 |

Table 8 illustrates shelf life results of Amori Pasta which was manufactured on Jan. 19, 2022.

TABLE 8

| | | | Date of analysis | | | |
|---|---|---|---|---|---|---|
| | | | 17 Feb. 2022 | 5 May 2022 | 16 Jun. 2022 | Specified |
| Tests | Phase | Units | A | B | C | Limits |
| MICROBIOLOGICAL | Total viable | cfu/g | <10 | 1.1 × 10² | 2.5 × 10² | Max 10⁴ |
| | count | | | | | |
| | Coliform | cfu/g | <10 | <10 | <10 | Max 10² |
| | E coli | org/g | Absent | Absent | Absent | Absent |
| | Salmonella | org/25 g | Absent | Absent | Absent | Absent |
| | Staphylococcus | org/g | Absent | Absent | Absent | Absent |
| | aureus | | | | | |
| | Yeast | cfu/g | <10 | <10 | <10 | Max 10² |
| | Mold | cfu/g | <10 | 4.0 × 10¹ | 4.5 × 10¹ | Max 10² |
| CHEMICAL | pH | — | 6.07 | 6.04 | 6.03 | Not |
| | | | | | | Specified |
| | Acidity as | g/100 g | 0.71 | 0.74 | 0.80 | Not |
| | citric acid | | | | | Specified |
| | anhydrous | | | | | |
| | Moisture | g/100 g | 7.10 | 7.60 | 7.89 | Max 12.5 |
| ORGANOLEPTIC | Appearance in | — | 5 | 5 | 5 | 3 to 5 |
| | terms of colour | | | | | |
| | Odour | — | 5 | 5 | 5 | 3 to 5 |
| | Taste | — | NA | NA | NA | 3 to 5 |
| | Texture/ | — | 5 | 5 | 5 | 3 to 5 |
| | Consistency | | | | | |

| | | | |
|---|---|---|---|
| Shelf life obtained | 1 | 12 | 18 |

Table 9 illustrates shelf life results of Rigatoni Pasta which was manufactured on Jan. 19, 2022.

TABLE 9

| | | | Date of analysis | | | |
|---|---|---|---|---|---|---|
| | | | 17 Feb. 2022 | 5 May 2022 | 16 Jun. 2022 | Specified |
| Tests | Phase | Units | A | B | C | Limits |
| MICROBIOLOGICAL | Total viable | cfu/g | <10 | 2.0 × 10² | 2.1 × 10² | Max 10⁴ |
| | count | | | | | |
| | Coliform | cfu/g | <10 | <10 | <10 | Max 10² |
| | E coli | org/g | Absent | Absent | Absent | Absent |
| | Salmonella | org/25 g | Absent | Absent | Absent | Absent |
| | Staphylococcus | org/g | Absent | Absent | Absent | Absent |
| | aureus | | | | | |
| | Yeast | cfu/g | <10 | <10 | <10 | Max 10² |
| | Mold | cfu/g | <10 | <10 | <10 | Max 10² |
| CHEMICAL | pH | — | 6.05 | 5.93 | 5.83 | Not |
| | | | | | | Specified |
| | Acidity as | g/100 g | 0.69 | 0.80 | 0.96 | Not |
| | citric acid | | | | | Specified |
| | anhydrous | | | | | |
| | Moisture | g/100 g | 8.13 | 8.40 | 8.72 | Max 12.5 |
| ORGANOLEPTIC | Appearance in | — | 5 | 5 | 5 | 3 to 5 |
| | terms of colour | | | | | |
| | Odour | — | 5 | 5 | 5 | 3 to 5 |
| | Taste | — | NA | NA | NA | 3 to 5 |
| | Texture/ | — | 5 | 5 | 5 | 3 to 5 |
| | Consistency | | | | | |

| | | | |
|---|---|---|---|
| Shelf life obtained | 1 | 12 | 18 |

Table 10 illustrates shelf life results of Penne Pasta which was manufactured on Jan. 19, 2022.

TABLE 10

| | | | Date of analysis | | | |
|---|---|---|---|---|---|---|
| | | | 17 Feb. 2022 | 5 May 2022 | 16 Jun. 2022 | Specified |
| Tests | Phase | Units | A | B | C | Limits |
| MICROBIOLOGICAL | Total viable | cfu/g | <10 | 3.0 × 10¹ | 4.0 × 10¹ | Max 10⁴ |
| | count | | | | | |
| | Coliform | cfu/g | <10 | <10 | <10 | Max 10² |
| | E coli | org/g | Absent | Absent | Absent | Absent |
| | Salmonella | org/25 g | Absent | Absent | Absent | Absent |
| | Staphylococcus | org/g | Absent | Absent | Absent | Absent |
| | aureus | | | | | |
| | Yeast | cfu/g | <10 | <10 | <10 | Max 10² |
| | Mold | cfu/g | <10 | <10 | <10 | Max 10² |
| CHEMICAL | pH | — | 6.03 | 5.91 | 5.79 | Not |
| | | | | | | Specified |
| | Acidity as | g/100 g | 0.65 | 0.76 | 0.84 | Not |
| | citric acid | | | | | Specified |
| | anhydrous | | | | | |
| | Moisture | g/100 g | 9.23 | 9.65 | 9.93 | Max 12.5 |
| ORGANOLEPTIC | Appearance in | — | 5 | 5 | 5 | 3 to 5 |
| | terms of colour | | | | | |
| | Odour | — | 5 | 5 | 5 | 3 to 5 |
| | Taste | — | NA | NA | NA | 3 to 5 |
| | Texture/ | — | 5 | 5 | 5 | 3 to 5 |
| | Consistency | | | | | |

| | | | |
|---|---|---|---|
| Shelf life obtained | 1 | 12 | 18 |

In Tables 6 to 10, A, B, C denote test done immediately after receiving the pasta product (Zero time), after 1 month in room conditions and 11 weeks in accelerated conditions, and thereafter 1 month in room conditions and 17 weeks in accelerated conditions. Fusilli Pasta, Macaroni Pasta, Amori Pasta, Rigatoni Pasta, and Penne Pasta as illustrated in the Tables 6 to 10 are prepared using the gluten free grains-based food composition of the present disclosure that includes combination of chickpea flour, red lentil flour, green moong dal flour or mung bean flour, brown rice flour, buckwheat flour, tapioca starch, guar gum, and flaxseed flour.

With reference to Tables 6 to 10, it is observed that the pasta products are free-from food pathogens such as Coliform, E coli, Salmonella, Staphylococcus aureus, Yeast, and Mold while the products are stored at an ambient condition or room temperature from 0 to 18 months. The total viable count of the pathogen is within the acceptable value. Similarly, the chemical attributes such as pH, acidity, moisture are stable and are in acceptable range while the products are stored at the ambient condition or room temperature from 0 to 18 months. The organoleptic attributes such as appearance, odour, texture, and taste are stable and are in acceptable range while the products are stored at the ambient condition or room temperature from 0 to 18 months.

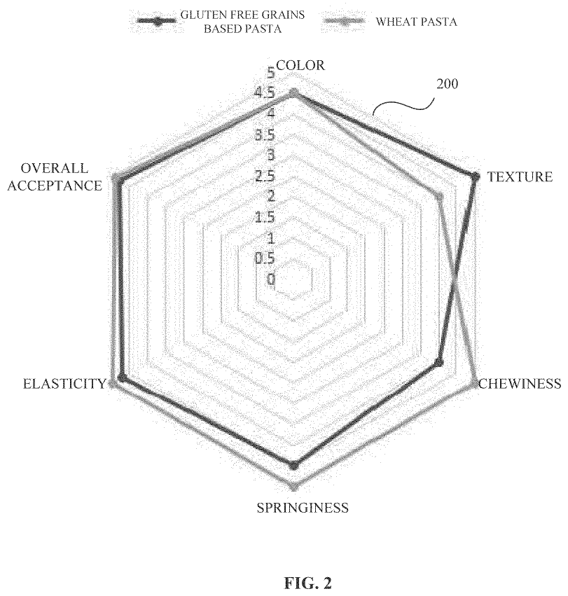

FIG. 2 is a graphical representation 200 of comparative sensory analysis between a nutrient rich, low glycemic index (GI), gluten free grains-based pasta and wheat pasta, according to some embodiments herein. From the graphical representation 200, it is observed that the gluten free grains-based pasta has color, texture, chewiness, springiness, and elasticity similar to the wheat pasta made from durum wheat. Further, overall sensory acceptance score of the gluten free grains-based pasta is similar to the wheat pasta made from durum wheat. As per the sensory analysis in the graphical representation 200, the gluten free grains-based pasta and the wheat pasta are similar on sensory profile.

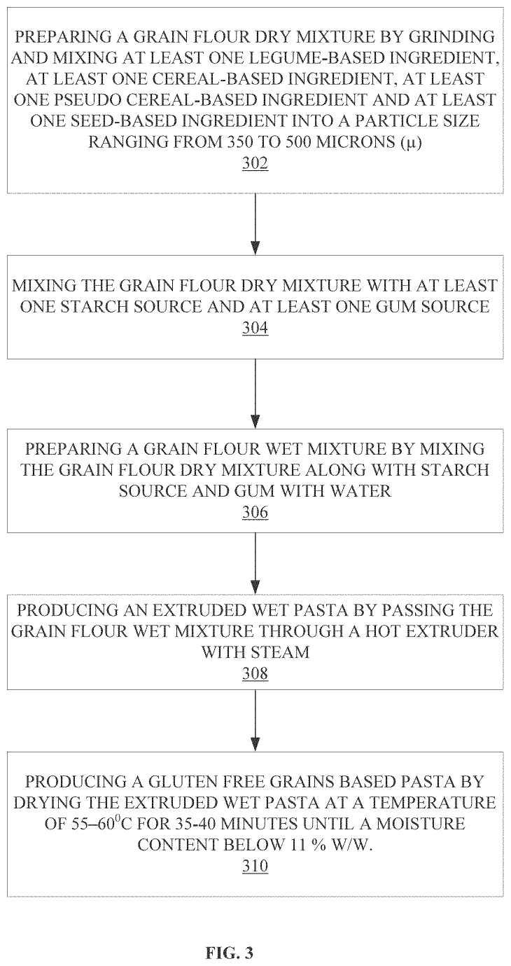

FIG. 3 illustrates a method of producing a nutrient rich, low glycemic index (GI), gluten free grains-based pasta, according to some embodiments herein. At a step 302, at least one legume-based ingredient, at least one cereal-based ingredient, at least one pseudo cereal-based ingredient and at least one seed-based ingredient are ground and mixed into a grain flour dry mixture with a particle size ranging from 350 to 500 microns (μ). The legume-based ingredient includes chickpea, lentil, and mung bean or green moong dal. The cereal-based ingredient includes brown rice. The pseudo cereal-based ingredient includes buckwheat. The seed-based ingredient includes flax seed. In some embodiment, 30% of chickpea, 30% of red lentil, 15% of mung bean or green moong dal, 10% of brown rice, 10% of buckwheat and 0.5% of flaxseed are ground, at an ambient temperature of 27 to 30 degree Celsius (° C.), into the flour mixture that includes chickpea flour, red lentil flour, mung bean flour or green moong dal flour, brown rice flour, buckwheat flour, and flaxseed flour, thereby denaturation of protein is lowered. The flour mixture is unrefined flour mixture. The flour mixture may not be kept for period of more than 2 days before processing.

At a step 304, the grain flour dry mixture is mixed with at least one starch source, and at least one gum source. The starch source may be tapioca starch. The gum source may be guar gum. In some embodiments, 4% of tapioca starch and 1% of guar gum is mixed with the flour mixture.

At a step 306, grain flour wet mixture is prepared by mixing water with the grain flour dry mixture along with starch and gum. A ratio of water and grain flour dry mixture includes 25:75

At a step 308, the grain flour wet mixture is passed through a hot extruder with steam to produce an extruded wet pasta. A ratio of starch and gum helps in cooking during an extrusion process which results in un-cracked pasta surface and holds network in pasta and smoothens surface. The hot extruder is at a temperature ranging from 90-110 degree Celsius (° C.). The grain flour wet mixture is extruded to a specific shape based on a type of pasta to be produced. Different types of pasta include, but not limited to, Spaghetti, Penne, Lasagne, Ravioli, Linguine, Rigatoni, Farfalle, Fusilli, Macaroni, and Cannelloni. In one embodiment, the penne size is 3+/−0.2 cm if the pasta is penne pasta.

At a step 310, the gluten free grains-based pasta is produced by drying the extruded wet pasta at a temperature of 55-60° C. for 35-40 minutes until a moisture content below 11% w/w. In some embodiments, the extruded wet pasta is dried at a temperature of 60-80° C. for a time period of 3-6 hours.

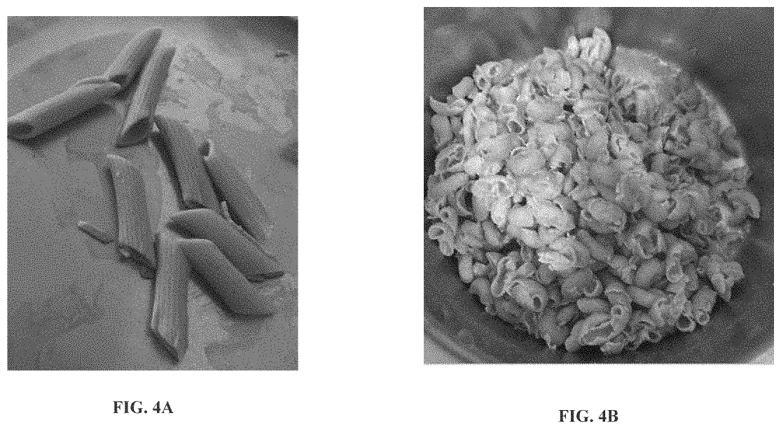

FIGS. 4A and 4B illustrate exemplary undesired results of pasta due to changing the concentration ranges of ingredients of the gluten free grains-based pasta. FIG. 4A is a penne pasta whose shape is affected after cooking due to changing the concentration ranges of the ingredients of the gluten free grains-based food composition of the present disclosure. FIG. 4B is a macaroni pasta whose shape is affected after cooking due to changing the concentration ranges of the ingredients of the gluten free grains-based food composition of the present disclosure. Each component at a given concentration in the grains based composition synergistically produces the nutrient rich, low glycemic index, gluten free grains based pasta with the shelf life from 0 to 18 months at an ambient condition. For example, a higher percentage of (>35%) of chickpea flour creates brittleness, while lower percentage (<25%) of chickpea flour creates more breakage. A higher percentage of (>35%) of red lentil flour creates off taste, while lower percentage (<25%) of red lentil flour lowers protein content. A higher percentage of (>20%) of mung bean flour creates beany taste, while lower percentage (<10%) of mung bean flour creates low protein product. A higher percentage of (>15%) of brown rice flour creates rough product, while lower percentage (<5%) of brown rice flour creates low fiber product. A higher percentage of (>10%) of buckwheat flour creates undesirable specs on pasta, while lower percentage (<5%) of buckwheat flour creates less in protein. A higher percentage of (>8%) of tapioca starch flour creates very hard pasta, while lower percentage (<1%) of tapioca starch flour creates broken pasta. A higher percentage of (>1.5%) of guar gum creates slimy pasta, while lower percentage (<0.5%) of guar gum creates broken pasta. A higher percentage of (>0.7%) of flax seed flour creates off-rancid taste, while lower percentage (<0.2%) of flax seed flour creates lower nutritional value.

The gluten free grains based pasta of the present disclosure is advantageous in that the grains-based pasta (60 g of uncooked pasta) includes high protein, high fiber and low net carbohydrates, thereby the grains-based pasta is suitable for protein and fiber deficient, celiac and diabetic populations. As the grains-based pasta is rich in protein and fiber, the grains-based pasta satisfies nutritional requirement of an individual. The grains-based pasta includes low glycemic index (GI), thereby suitable for diabetic populations. Further, the grains-based pasta includes high shelf life, sensorially acceptable taste and improved protein digestibility.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of employed herein is for the purpose of description and not of limitation. Therefore, while the embodiments herein have been described in terms of preferred embodiments, those skilled in the art will recognize that the embodiments herein can be practiced with modification within the scope.

What is claimed is:

1. A nutrition rich, low glycemic index (GI), gluten free grains-based pasta, comprising:
(i) 60% weight/weight ti w)) to 90% w/w of the at least one legume-based ingredient;
(ii) 5% w/w to 15% w/w of the at least one cereal-based ingredient;
(iii) 5% w/w to 10% w/w of the at least one pseudo cereal ingredient;
(iv) 1% w/w to 8% w/w of the at least one starch source;
(v) 0.5% w/w to 1.5% w/w of the at least one gum source; and
(vi) 0.2% w/w to 0.7% w/w of the at least one seed-base ingredient, wherein the pasta is shelf stable at an ambient condition.

2. The pasta of claim 1, wherein
(i) the at least one legume-based ingredient comprises (i) 25% w/w to 35% w/w of a first legume-based ingredient that comprises chickpea flour, (ii) 25% w/w to 35% w/w of a second legume-based ingredient that comprises red lentil flour, and (iii) 10% w/w to 20% w/w of a third legume-based ingredient that comprises mu ng bean flour;
(ii) the at least one cereal-based ingredient comprises 5% w/w to 15% w/w of brown rice flour;
(iii) the at least one pseudo cereal ingredient comprises 5% w/w to 10% w/w of buckwheat flour;
(iv) the at least one starch source ingredient comprises 1% w/w to 8% w/w of tapioca starch flour;
(v) the at least one gum source comprises 0.5% w/w to 1.5% w/w of guar gum; and
(vi) the at least one seed-based ingredient comprises 0.2% w/w to 0.7% w/w of flax seed flour.

3. The pasta of claim 1, wherein the pasta comprises a low GI index of 52.94.

4. The pasta of claim 1, wherein the pasta has the shelf lite of 18 months at an ambient condition.

5. The pasta of claim 1, wherein the pasta has a pH ranging from 6 to 6.65.

6. The pasta of claim 1, wherein the pasta (100 grams (g)) has a nutrition profile that comprises (i) 344 kilocalories (kcal) of energy, (ii) 18 g of protein, (iii) 68 g of carbohydrates, (iv) 1 a of total sugar, (v) 14 g of dietary fiber, (vi) 3 g of total fat, (vii) 0.4 g of saturated fat, (viii) 0.5 g of monosaturated fatty acids, and (ix) 1.2 g of polyunsaturated fatty acids.

7. The pasta of claim 1, wherein the pasta (100 grams (g)) provides minerals that comprises (i) 80 milligrams (mg) of calcium (Ca), (ii) 137.7 mg of magnesium (Mg), (iii) 935 mg of potassium (K), (iv) 4 mg of iron (Fe), and (v) 2.5 mg of zinc (Zn).

8. The pasta of claim 1, wherein the pasta has a protein digestibility-corrected amino acid score (PDCAAS) of 0.8 which is higher than a regular wheat pasta.

9. The pasta of claim 1, wherein the pasta comprises 14.53 g digestible protein in 100 grams (g), wherein the pasta comprises (i) 50.8 milligrams (mg) of digestible lysine per gram (g) protein, (ii) 32.7 mg of threonine per gram of protein, (iii) 10.8 mg of digestible tryptophan per gram of protein, (iv) 38.9 mg of digestible histidine per gram of protein, (v) 35 mg of isoleucine per gram of protein, (vi) 66 mg of digestible leucine per gram of protein, (vii) 38.4 mg of digestible valine per gram of protein, (viii) 103.9 mg of digestible phenylalanine and tyrosine per gram of protein, and (ix) 44.6 mg of digestible methionine and cysteine per gram of protein.

10. The pasta of claim 1, wherein the pasta has a sensory score of 4.8 which is similar to a regular wheat pasta.

11. A method of producing a high nutrition, low glycemic index (GI), gluten free grains-based pasta, comprising:
(i) preparing a grain flour dry mixture by grinding and mixing (a) 60% weight/weight w/w to 90% w/w of at least one legume-based ingredient, (b) 5% w/w to 15% w/w of the at least one cereal-based ingredient, (c) % w/w to 10% w/w of at least one pseudo cereal ingredient and (d) 0.2% w/w to 0.7% w/w of seed-based ingredient into with a particle size ranging from 350 to 500 microns (μ);
(ii) mixing the grain flour dry mixture with 1% w/w to 8% w/w of at least one starch source and 0.5% w/w to 1.5% w/w of at least one gum source;
(iii) forming a grain flour wet mixture by mixing the grain flour dry mixture along with starch and gum with water, wherein a ratio of water and grain flour dry mixture is 25:75;
(iv) producing; an extruded wet pasta by passing the grain flour wet mixture through a hot extruder with steam wherein the hot extruder is at a temperature ranging from 90-110 degree Celsius (° C.); and
(v) producing the high nutrition, low glycerine index (GI), gluten free grains-based pasta by passing the extruded wet pasta through a dryer which is at a temperature ranging from 55-60° C. for 35-40 minutes until a moisture content below 11% w/w, wherein pasta has a shelf life from 0 to 18 months at an ambient condition.

12. The method of claim 11, wherein
(i) the at least one legume-based ingredient comprises (i) 25% w/w to 35% w/w of a first legume-based ingredient that comprises chickpea flour, (ii) 25% w/w to 35% w/w of a second legume-based ingredient that comprises red lentil flour, and (iii) 10% w/w to 20% w/w of a third legume-based ingredient that comprises mung bean flour;
(ii) the at least one cereal-based ingredient comprises 5% w/w to 15% w/w of brown rice flour;
(iii) the at least one pseudo cereal ingredient comprises 5% w/w to 10% w/w of buckwheat flour;
(iv) the at least one starch source ingredient comprises 1% w/w to 8% w/w of tapioca starch flour,
(v) the at least one gum source comprises 0.5% w/w to 1.5% w/w of guar gum; and
(vi) the at least one seed-based ingredient comprises 0.2% w/w to 0.7% w/w of flax seed flour.

13. The method of claim 11, wherein the pasta comprises a low GI index of 52.94.

14. The method of claim 11, wherein the pasta has a pH ranging from 6 to 6.65.

15. The method of claim 11, wherein the pasta (100 grams (g)) has a nutrition profile that comprises (i) 344 kilocalories (kcal) of energy, (ii) 18 g of protein, (iii) 68 g of carbohydrates, (iv) 1 g of total sugar, (v) 14 g of dietary fiber, (vi) 3 g of total fat, (vii) 0.4 g of saturated fat, (viii) 0.5 g of monosaturated fatty acids, and (ix) 1.2 g of polyunsaturated fatty acids.

16. The method of claim 11, wherein the pasta (100 grams (g)) provides minerals that comprises (i) 80 milligrams (mg) of calcium (Ca), (ii) 137.7 mg of magnesium (Mg), (iii) 935 mg of potassium (K), (iv) 4 mg of iron (Fe), and (v) 2.5 mg of zinc (Zn).

17. The method of claim 11, wherein the pasta has a protein digestibility-corrected amino acid score (PDCAAS) of 0.8 which is higher than a regular wheat pasta.

18. The method of claim 11, wherein the pasta comprises 14.53 g digestible protein in 100 grams (g), wherein the pasta comprises (i) 50.8 milligrams (mg) of digestible lysine per gram (g) of protein, (ii) 32.7 mg of threonine per gram of protein, (iii) 0.8 mg of digestible tryptophan per gram of protein, (iv) 38.1 mg of digestible histidine per gram of protein, (v) 35 mg of isoleucine per gram of protein, (vi) 66 mg of digestible leucine per gram of protein, (vii) 38.4 mg of digestible valine per gram of protein, (viii) 103.9 mg of digestible phenylalanine and tyrosine per gram of protein, and (ix) 44.6 mg of digestible methionine and cysteine per gram of protein.

19. The method of claim 11, wherein the pasta has a sensory score of 4.8 which is similar to a regular wheat pasta.
